(19) United States
(12) Patent Application Publication
(10) Pub. No.: US 2008/0201645 A1
(43) Pub. Date: Aug. 21, 2008

(54) Method and Apparatus for Deploying Portlets in Portal Pages Based on Social Networking

(76) Inventors: Arthur R. Francis, Raleigh, NC (US); Ruthie D. Lyle, Durham, NC (US); Veronique L. Moses, Raleigh, NC (US); Denny Pichardo, Raleigh, NC (US)

Correspondence Address: IBM CORP. (RALEIGH SOFTWARE GROUP);c/o Rudolf O Siegesmund Gordon & Rees, LLP, 2100 Ross Avenue, Suite 2800, DALLAS, TX, 75201, US

(21) Appl. No.: 11/677,076

(22) Filed: Feb. 21, 2007

(51) Int. Cl. G06F 3/00; G06F 3/048

(52) U.S. Cl. 715/742; 715/764

(57) ABSTRACT

A Portal Page Customizer (PPC) provides a tagging component and a portal page generator that enables a user to quickly display portlets most preferred by a community of portlet users. Each tag is associated with one or more portlet. A user can add new descriptive tags to portlets using tools on the portal page. When a user selects a tag from a tag cloud, the PPC displays portlets associated with the selected tag.

### FIELD OF THE INVENTION

The present invention relates generally to electronic data processing and relates specifically to deploying portlets or web parts on portal pages based on social networking.

### BACKGROUND OF THE INVENTION

A “metatag,” referred to herein as a “tag,” is a keyword or descriptive term associated with an item as means of classification. Tags are typically used in the metadata of items such as computer files, web pages, digital images, and internet bookmarks. Tags can be added automatically or manually when the item is created. Tags can also be added automatically or manually when the item is accessed, copied, transferred or classified.

One use of tags gaining in popularity is the generation of tag clouds. Tag clouds have been popularized by TECHNORATI, an Internet search engine used for searching blogs, and FLICKR, a web based collection of photographs. Tag clouds allow web users to select displayable web pages from an ordered list of tags. In the most common form, tag clouds display the most popular tags in a larger font while listing the tags in alphabetical order. Tag cloud software records the number of times users select a tag in the tag cloud. By displaying tags by popularity, tag clouds reflect the preferences of a community of users. When a user clicks on a tag, the user is directed to a web page or listing of web pages that relate to the selected tag.

Many web pages are set up as a “portal page,” which is a web page comprising a collection of non-overlapping portlet windows where each portlet window displays a portlet. A “portlet” is a component of a web page that may provide useful information to the user. “Portlet applications” run in each portlet window on a portal page. Examples of portlet applications include email, weather reports, discussion forums, maps, and image viewers.

Today the administration portal pages is implemented in a fairly rigid and centrally managed process. Portal page users are able to select and display only portlets configured and approved by a central portal administrator. Some prior art has allowed for seeding or polling of users about the types of portlets they wish to display. Central portal administrators use the seeding and polling information to determine what portlets to provide. However, users cannot quickly display portlets based on frequency of use by other users. Web users cannot quickly assign their own tags to portlets and immediately have the ability to display portlets based on their own preferences.

The capability for each user in a community of users to label each portlet with which they interact with their own tags is needed. A mechanism to display the portlets most frequently associated with a tag by previous users would capitalize on the community's collective knowledge of such issues as which portlets are easiest to use, which are most reliable, and which provide the most information. Additional utility could be derived from allowing users to quickly sort the tags, associated with one or more portlets, by how frequently the portlets associated with those tags were favored by the users in the portal community. Thus, the ability for users to create custom tags for portlets, to display the tags in a tag cloud, and to display preferred portlets in a portal page is needed.

### SUMMARY OF THE INVENTION

A Portal Page Customizer (PPC) provides a tagging component and a portal page generator that enables a user to quickly display portlets most preferred by a community of portlet users. Each tag is associated with one or more portlet. A user can add new descriptive tags to portlets using tools on the portal page. When a user selects a tag from a tag cloud, the PPC displays portlets associated with the selected tag.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is a webpage with a portlet tag cloud;

FIG. 2 is an exemplary computer network;

FIG. 3 describes the programs and files in memory on a computer;

FIG. 4 is a flowchart of a Tagging Component; and

FIG. 5 is a flowchart of a Portal page Generator.

### DETAILED DESCRIPTION OF THE PREFERRED EMODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory. The term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Portal Page Customizer” (PPC).

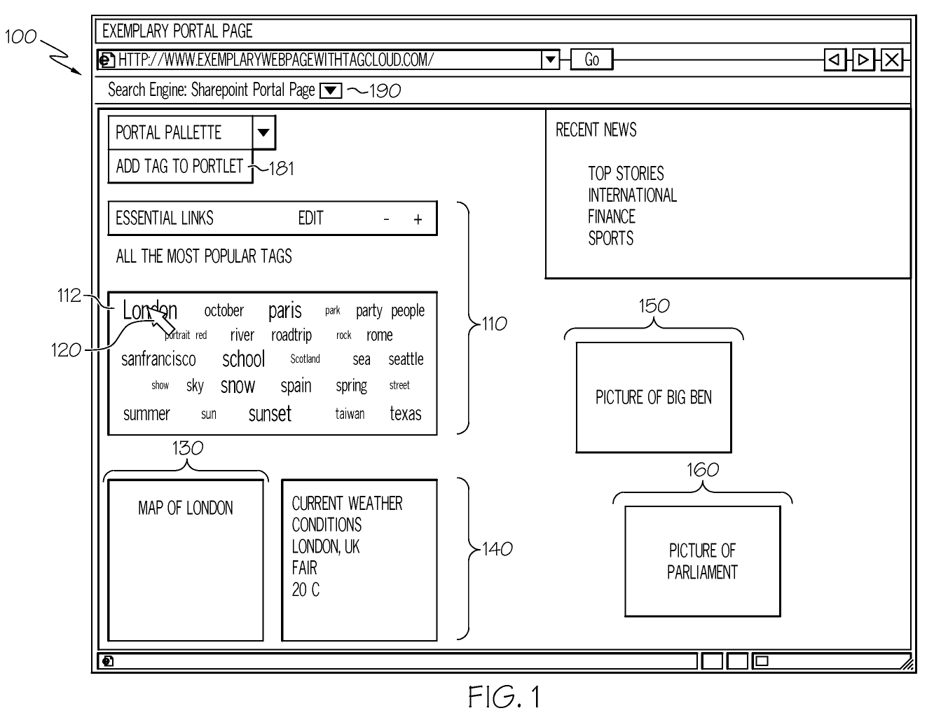

FIG. 1. shows an exemplary Internet Browser 100 displaying portlet tag cloud 110. Each metatag in tag cloud 110 is associated with a set of one or more portlets previously assigned a metatag by a user or portal administrator. The name of the metatag provides information about the associated portlet, such as categorization information. When a user selects a metatag with mouse cursor 120, such as London 112 shown in tag cloud 110, the portlets associated with that metatag are displayed in portal page 100 or in a newly generated portal page (not shown). The initial portlets that display may only be a subset of the portlets associated with the metatag. For example, this subset could be the most popular portlets associated with the selected meta tag. In the example on portal page 100, the portlets include: Map of London portlet 130, and Current Weather Conditions portlet 140. Additionally, an expanded set of portlets that correspond to the selected metatag could display on the portal page, for example: Picture of Big Ben portlet 150, and Picture of Parliament portlet 160. The user could manually select to display portlet 150 and portlet 160 on portal page 100 and to associate portlet 150 and portlet 160 with the user's portlet preferences for metatag London 112. The user could, as another option, use dropdown menu add function 181 to add one or more tags to portlets 130-160. Alternatively, the user could use the “+” icon on the toolbar of 110 to add tags to portlets. Similarly, the user as another option, can simultaneously assign a tag to all portlets currently displayed on the portal page with a single operation. A user could also use IBM Websphere Portal's Portlet Palette or MICROSOFT's Web/Parts Gallery in sharepoint portal 190 to access portlets for tagging.

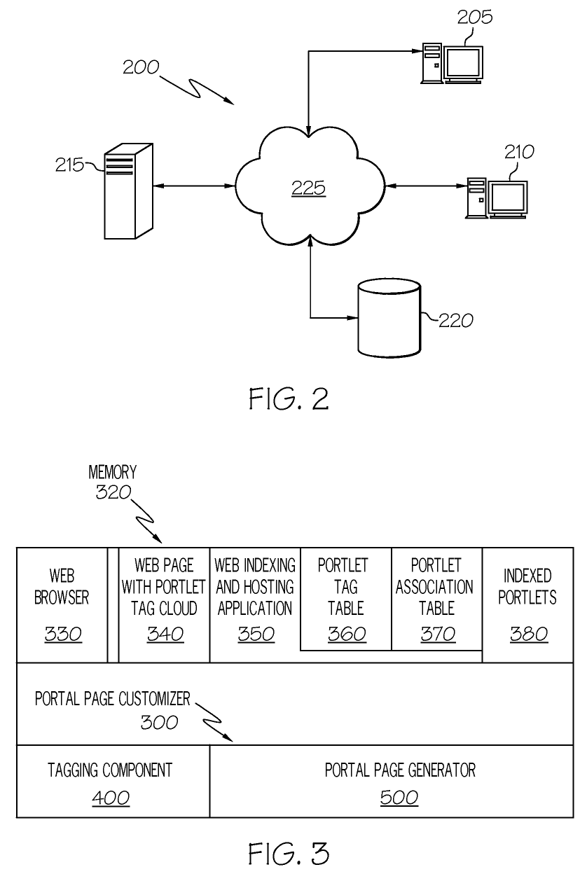

The PPC is described with reference to an exemplary network of hardware devices, depicted in FIG. 2. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 200 has only a limited number of nodes, including workstation computer 205, workstation computer 210, server computer 215, and persistent storage 220. Network connection 225 comprises all hardware, software, and communications media necessary to enable communication between network nodes 205-220. Unless otherwise indicated in context below, all network nodes use publicly available protocols or messaging services to communicate with each other through network connection 225.

PPC 300 typically is stored in a memory, represented schematically as memory 320 in FIG. 3. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further PCC 300 may reside in more than one memory distributed across different computers, servers, logical partitions, or other hardware devices. The elements depicted in memory 320 may be located in or distributed across separate memories in any combination, and PCC 300 may be adapted to identify, locate and access any of the elements and coordinate actions, if any, by the distributed elements. Thus, FIG. 3 is included merely as a descriptive expedient and does not necessarily reflect any particular physical embodiment of memory 320. As depicted in FIG. 3, though, memory 320 may include additional data and programs. Of particular import to PPC 300, memory 320 may include web browser 330, web page with portlet tag cloud 340, web indexing and hosting application 350, portlet tag table 360, portlet association table 370, and indexed portlets 380 with which PPC 300 interacts. PPC 300 comprises two components: tagging component 400, and portal page generator 500. In a preferred embodiment, the components of PPS 300 are a script residing on web page with portlet tag cloud 340.

A user of web browser 330 accesses web page with portlet tag cloud 340 hosted by web indexing and hosting component 350. Although web indexing and hosting component 350 is shown here as a single application, the indexing functions and hosting functions can be, and often are, separate applications. The indexing functions of web indexing and hosting application 350 collects tags from indexed portlets 380 and stores the tags in portlet tag table 360. Additionally, web indexing and hosting application 350 collects other statistical information related to indexed portlets 380, such as how often a portlet is displayed by a user and added to a portal page or when a new tag is associated with a portlet by a user. The collected information is stored in portlet association table 370 with the corresponding tags. When a user changes association between a portlet and a tag, tagging component 400 updates portlet association table 370. PPC 300 generates a tag cloud on Web Page 340 using tags and tag attributes from portlet tag table 360. An example of a tag attribute could be the font size of a tag, with increasing size for greater frequency of use. The portlet tag cloud may display in its own portlet, in a fly-out or pop-up window, on a navigation bar, or directly on the portal page. PPC 300 sorts the tag cloud alphabetically by default. The default tags initially associated with each portlet are assigned by the portal administrator.

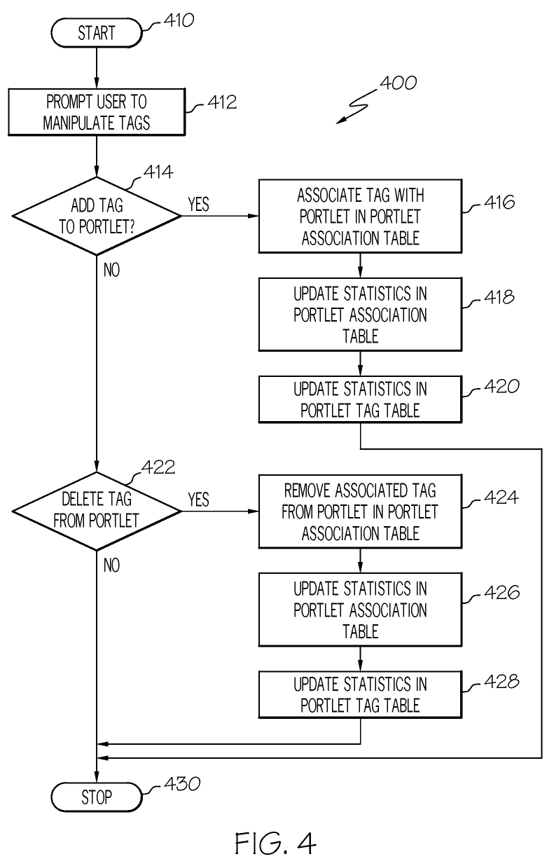

As shown by FIG. 4, tagging component 400 becomes available when web browser 330 accesses web page with portlet tag cloud 340. Tagging Component 400 starts (410) when a user selects a displayed portlet to manipulate tags assigned to a portlet by clicking on the portlet with a mouse, or selecting an add or delete function on a tool bar or dropdown menu. Tagging component 400 prompts the user to assign or remove a tag assignment for the selected portlet (412). If the user selects to add a tag to a portlet at step 414, the tagging component assigns the tag to the portlet in portlet association table 370 (416). Tagging component 400 updates portlet association table 360 with statistics related to the selected portlet (418). Statistics for a portlet may include how frequently the selected portlet is tagged by users. Tagging component 400 updates portlet tag table 360 with statistics related to the added tag (420). Statistics for a tag may include how frequently a tag is assigned to a particular portlet. If the user assigns a previously unused tag to the selected portlet, the new tag is added to portlet tag table 360 to be available for generating the tag cloud on web page 340. After updating portlet tag table 360, tagging component 400 stops (430). If a user deletes a tag association with the selected portlet at step 422, tagging component 400 removes the tag from the selected portlet in portlet association table 370 (424). Tagging component 400 updates portlet association table 360 with statistics related to the reduced use of selected portlet (426). Tagging component 400 also updates portlet tag table 360 with statistics relating to the reduced use of this tag (428). After updating portlet tag table 360, tagging component 400 stops (430).

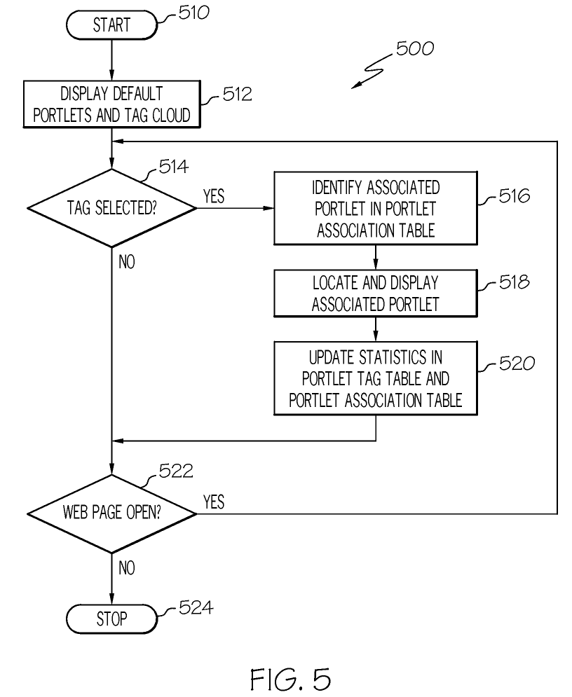

As shown by FIG. 5, portal page generator 500 starts whenever Web Page with Portlet Tag Cloud 340 is first opened by Web Browser 330 (510). Portal page generator 500 displays default portlets, and displays portlet tags from portlet tag table 360 as a typical tag cloud (512). If a user selects a tag in the tag cloud (514), Portal page generator 500 identifies portlets associated with the tag in portlet association table 370 (516). Portal page generator 500 locates the associated portlets in indexed portlets 380 and displays the associated portlets (518). Portal page generator 500 updates statistics in portlet tag table 360 and portlet association table 370 (520), and displays the portlets associated with the selected portlet tag or the default portlets for that window on the existing or a new portal page (518). For as long as Web Page with Portlet Tag Cloud 340 remains active (522), portal page generator 500 goes back to step 514. When Web Page with Portlet Tag Cloud 340 closes, portal page generator 500 stops (524).

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for displaying portlets on a web page, the computer implemented process comprising:
associating a first metatag with a first portlet;
displaying the first metatag in a tag cloud, wherein the tag cloud comprises a plurality of metatags reflecting social networking community preferences for a plurality of portlets; and
responsive to a user selecting the first metatag from the tag cloud, displaying the first portlet associated with the first metatag.

2. The computer implemented process of claim 1 wherein the first metatag is associated with more than one portlet.

3. The computer implemented process of claim 2 wherein responsive to a user selecting the first metatag from the tag cloud, displaying the more than one portlet associated with the first metatag.

4. The computer implemented process of claim 1 wherein the user can associate new metatags with a portlet.

5. The computer implemented process of claim 1 wherein the user can associate new portlets with a metatag.

6. An apparatus for displaying portlets on a web page, the apparatus comprising:
a processor;
a memory connected to the processor;
a web indexing and hosting application running in the memory;
a plurality of portlets in the memory capable of being displayed on a web page a web page displaying a tag cloud;
a portal page customizer program in the memory operable to associate a first metatag with a first portlet, displaying the first metatag in the tag cloud, wherein the tag cloud comprises a plurality of metatags reflecting social networking community preferences for a plurality of portlets, and responsive to a user selecting the first metatag from the tag cloud, display the first portlet associated with the first metatag.

7. The apparatus of claim 6 wherein the first metatag is associated with more than one portlet.

8. The apparatus of claim 7 wherein responsive to a user selecting the first metatag from the tag cloud, the portal page customizer program displays the more than one portlet associated with the first metatag.

9. The apparatus of claim 6 wherein the portal page customizer program allows the user to associate new metatags with a portlet.

10. The apparatus of claim 6 wherein the portal page customizer program allows the user to associate new portlets with a metatag.

11. A computer readable memory containing a plurality of instructions to cause a computer to display portlets on a web page, the plurality of instructions comprising:
a first instruction to associate a first metatag with a first portlet;
a second instruction to displaying the first metatag in the tag cloud, wherein the tag cloud comprises a plurality of metatags reflecting social networking community preferences for a plurality of portlets; and
responsive to a user selecting the first metatag from the tag cloud, a third instruction to display the first portlet associated with the first metatag.

12. The computer readable memory of claim 11 wherein the first metatag is associated with more than one portlet.

13. The computer implemented process of claim 12 wherein responsive to a user selecting the first metatag from the tag cloud, the third instruction displays the more than one portlet associated with the first metatag.

14. The computer readable memory of claim 11 wherein the user can associate new metatags with a portlet.

15. The computer readable memory of claim 11 wherein the user can associate new portlets with a metatag.
